(19) United States
(12) Patent Application Publication
(10) Pub. No.: US 2007/0271606 A1
(43) Pub. Date: Nov. 22, 2007

(54) Apparatus and method for establishing a VPN tunnel between a wireless device and a LAN

(76) Inventors: Keith R. Amann, Westminster, CO (US); Christophe Durand, Superior, CO (US); Michael W. House, Loveland, CO (US); David L. Roach, Silverthome, CO (US); Jeffery Steed, Santa Barbara, CA (US)

Correspondence Address: ROBERT C. SCHLUER, 45 GROTON ROAD, SHIRLEY, MA, 01464, US

(21) Appl. No.: 11/436,132

(22) Filed: May 17, 2006

(51) Int. Cl. G06F 15/16

(52) U.S. Cl. 726/15

(57) ABSTRACT

A local area network includes one or more wireless access points for receiving and sending voice and data messages from and to a mobile wireless communications device and a router to manage the delivery of messages to either a DHCP server, a VPN server, or the wireless access points. The DHCP server provides configuration parameters specific to a client requesting DHCP information. The VPN server operates, in conjunction with wireless communications devices to perform key exchange, mode configuration, client authentication, and to maintain the security of a VPN session. The wireless communications device includes a hybrid VPN client that operates, in conjunction with the LAN, to initiate the establishment of a VPN tunnel between the wireless communications device and the VPN server. The hybrid VPN client includes both software and hardware modules that operate together to limit communications latency during the establishment and maintenance of a VPN session.

### FIELD OF THE INVENTION

This invention generally relates to establishing a VPN session between a mobile, wireless communications device and a wireless local area network. Background of the invention: At times, it is necessary to conduct communications sessions between two points, on a wired public or private network, in a secure manner and in a manner that permits the device that is sending or receiving information over the network to be authenticated by the network. One method for establishing a secure, authenticated communications session is referred to as a Virtual Private Network or VPN. A VPN is typically used when information is being sent over a public network such as the Internet. However, the infrastructure and expertise needed to manage and operate a VPN tend to come at a higher cost than other secure communication methods. With the advent of wireless LAN's and the inherent insecurity associated with broadcasting information over radio waves, alternative, less expensive methods for ensuring the security of communications sessions were developed.

One scheme that is used to provide wireless LAN communication security is the well known Wired Equivalent Security or WEP. WEP was developed as part of the IEEE 802.11 standard and uses the RC4 stream cipher for security and the CRC-32 checksum for integrity. Unfortunately, a number of serious weaknesses were identified with WEP and so its use has been largely discontinued in favor of another method called Wi-Fi Protected Access or WPA and more recently WPA-2. WPA was developed as an intermediate solution to take the place of WEP while IEEE 802.11i was being developed. Subsequently, WPA-2 was developed to implement the mandatory elements of 802.11i. Although WPA and WPA-2 offer security improvements over the earlier WEP scheme, WPA does not use the most secure encryption algorithm available and while WPA-2 does use a more secure encryption algorithm-than WPA, it does not efficiently manage hand-off from one network access point to another network access point in the event the wireless communications device, such as a phone, is roaming. The inability to efficiently manage hand-off adds latency to a communications session which is particularly noticeable during voice communication sessions.

In order to solve the latency problem during roaming and to provide the highest possible security for wireless network communications, network managers can elect to implement VPN functionality on a network. As opposed to a typical non-secure communications session, there is a significant amount of additional overhead associated with the establishment and maintenance of a VPN session. The majority of this additional overhead is needed in order to authenticate the wireless communication devices which will participate in a communications session, to validate messages and to encrypt or decrypt the information being transmitted or received by the wireless communications devices during the communications session. The overhead functionality associated with the authentication, validation and encryption processes in a wireless LAN is usually referred to as a wireless VPN client.

Typically, VPN clients for wired or wireless communications devices are implemented in software so that they can be conveniently and easily downloaded from a remote server onto a wireless communications device. Less typically, these VPN clients are implemented in hardware and either incorporated into the design of the communications device or implemented as a smart card for insertion into the communications device as an option. One software VPN client is described in United States patent application 2004/0268148 A1 and assigned to Samsung Electronics Co. As described on page 2 starting with the description of FIG. 2, the VPN client is installed in the mobile device by downloading the client using an ordinary web browser. Once installed in the mobile device, the VPN client operates to communicate with a security service manager server in order to establish and maintain a secure and authenticated communication session. Another VPN client is described in U.S. Pat. No. 6,079,020 assigned to VPnet Technologies, Inc. As explained in column 6, starting on line 25, the VPN client can be implemented in either software or in hardware. The structure and operation of the VPN client is described starting in column 8, on line 41. US patent application 2004/0208155 A1 describes a VPN client implemented in hardware. As explained on page one, paragraph 6, a hardware implementation is used in order maintain the performance of a mobile communication system. Page 6, paragraph 27 of WO2005/057341 A2 assigned to Koolspan, Inc. describes a hardware implementation of a VPN client which in this case is contained in a smart card. The smart card is inserted into a wireless communications device to provide VPN functionality. The applicant describes an advantage of the smart card VPN implementation as being that it provides a technique for remote, secure access without requiring a VPN client program.

Generally speaking, VPN clients are implemented in software in order to facilitate the downloading or updating, from a remote server, of the client onto a communications device and VPN clients are implemented in hardware in order to accelerate the establishment and maintenance of a VPN session. One problem with implementing a software VPN client into a wireless communications device is that these devices are usually small and, if inexpensive, they typically have limited processing capability. Implementing a software VPN client on such a small, inexpensive device usually results in sacrificing performance, which equates to additional latency during a communications session. Specifically, this latency manifests itself to the user of a wireless communications device as a delay between the time the user dials a number and when the VPN session is established and as a delay between the time a voice message is transmitted from one wireless communications device to a second wireless communications device and a response is received back to the first device from the second device. Furthermore, mobile, wireless communications devices, such as a phone, typically receive their power from a battery. This latency also manifests itself to the user in shorten battery life and the need to recharge more frequently which is often not convenient.

A solution typically employed to solve the above latency problem is to replace the existing processor, which the wireless phone VPN client uses to perform the key exchange, mode configuration, and encryption functionality, with a more powerful processor. While using a more powerful processor would solve the latency problem, it comes at the expense of higher cost and higher power consumption, which for a wireless device using battery power results in shorter battery life. Another solution to the latency problem is to implement the client VPN functionality in hardware. Unfortunately, as the VPN standard is not static, implementing client VPN functionality in hardware is somewhat limiting if it becomes necessary to update the VPN client functionality.

Therefore, it would be advantageous if VPN client functionality could be implemented in a small, inexpensive, battery operated wireless communications device, such as a phone, in a manner that the user would perceive no difference in latency between an unsecured and secured communications session. Further, it would be advantageous to design a VPN client to establish and maintain a VPN session without having to replace the existing processor, used for non-secure communication sessions, with a more powerful processor, i.e., a processor with a faster clock rate, wider buses, etc., without an appreciable loss of battery life and without adding to communication latency. In this context, “appreciable loss” equates to approximately one percent or less loss in battery life. We have designed this hybrid VPN client so that there is no measurable increase in latency for the audio communication and only a slight increase in the initial acquisition time due to establishing a VPN tunnel. This increase is approximately one-half second. Also, there is no increase in handoff latency. We have designed a hybrid VPN client to include a software portion and a hardware portion that work cooperatively to establish and maintain a VPN session. This hybrid VPN client adds very little extra cost to the device which in the case of our embodiment is the cost of the ASIC device which is about $5.00, provides communications latency that is comparable to devices using more powerful and more expensive processors, and uses minimally more power.

### SUMMARY OF THE INVENTION

The present invention provides for a hybrid VPN client apparatus and method that is implemented on a wireless communications device in a LAN environment to initialize and maintain a secure VPN link. The hybrid VPN client includes functionality in a software portion and functionality in a hardware portion where the division of functionality between the software portion and the hardware portion is such that the communications latency between two wireless communications is minimized and where the consumption of power by a wireless communications device during a secure VPN communications session is no greater than during an non-secure communications session.

In one embodiment of our invention, the software portion of the hybrid VPN client includes instructions that are used to run the hardware portion of the hybrid VPN client and to communicate with the LAN.

In another embodiment of our invention, the hardware portion of the hybrid VPN client includes a plurality of packet security algorithms that are stores on an application processor and in another embodiment, the packet security algorithms include encryption algorithms, hash algorithms, and a large number algorithm.

In yet another embodiment of our invention, the hardware portion and the software portion of the hybrid VPN client operate together to support a process for the initialization of a VPN link.

In another embodiment of our invention, the VPN link initialization process is a three-phase process where the first phase is a setup phase for establishing an initial security association between a LAN device and a preconfigured wireless communication device, the second phase is a mode configuration stage for loading an IP address from the LAN device to the preconfigured wireless communications device, and the third phase is a parameter negotiation stage wherein the initial security association established in the first phase is used to create a permanent security association that is used for the communication of information over a secure VPN link.

In yet another embodiment of our invention, the wireless communications devices are preconfigured to include a DHCP address, a VPN server address, and security association settings.

In another embodiment of our invention, the hybrid VPN client employs a method for initiating a secure VPN link that minimizes communications latency between the wireless communications device and the LAN by employing a plurality of instructions in a software portion of the hybrid VPN client to manage the operation of a hardware portion of the hybrid VPN client and to access a plurality of operational parameters stored in the preconfigured wireless communications device in order to complete a first phase of a secure VPN link initialization process, and by employing a plurality of instructions in a software portion of the hybrid VPN client to manage the operation of a hardware portion of the hybrid VPN client and to access a plurality of operational parameters stored in the preconfigured wireless communications device in response to one or more requests from the LAN to complete a second phase of the secure VPN link initialization process, and by employing a plurality of instructions in a software portion of the hybrid VPN client to manage the operation of a hardware portion of the hybrid VPN client and to access a plurality of operational parameters stored in the preconfigured wireless communications device in response to one or more requests from the LAN to complete a third phase of a secure VPN link initialization process.

In another embodiment of our invention, the operational parameters stored in the wireless communications device are an IP address, a public key, a private key, configuration information, and identification information.

### BRIEF DESCRIPTION OF THE DRAWINGS

FIG. 1 is a high level functional block diagram of a LAN incorporating wireless communications devices.

FIG. 2 is a functional block diagram of a wireless phone

FIG. 3 is a functional block diagram of a DSP incorporated into the wireless phone design.

FIG. 4 is a high level block diagram showing the packet security algorithms of the preferred embodiment of the invention.

FIG. 5a is a logical flow diagram of phase 1 of an internet key exchange process.

FIG. 5b is a continuation of the logical flow diagram of FIG. 5a.

FIG. 6 is a logical flow diagram of a mode configuration exchange process.

FIG. 7 is a logical flow diagram of phase 2 or an internet key exchange process.

FIG. 8a is a logical flow diagram showing the process by which a wireless phone sends and receives voice messages over a VPN link.

FIG. 8b is a continuation of the logical flow diagram of FIG. 8a.

### DETAILED DESCRIPTION OF THE INVENTION

In order to establish a secure VPN link between a communications network device, such as a VPN server, and a communications device with a VPN client, whether it is a wired or wireless device such as a wireless phone, it is standard practice to use the Internet Key Exchange (IKE) protocol, defined by IETF RFC 2409, to setup a security association (SA) between a VPN server and a wireless phone. Typically, the IKE protocol is described as a two phase process that enables the VPN server and the VPN client residing on the wireless phone to negotiate to setup the SA, which is a set of attributes negotiated between the VPN server and VPN client used to establish a protected communications link between them. More specifically, the mandatory attributes which must be negotiated are encryption algorithms such as DES or 3DES, hash algorithms such as MD5 and SHA, the authentication method via pre-shared keys, and information about a group over which to do the Diffie-Hellman key exchange. Additionally, the IKE process allows the VPN server to perform an optional mode configuration process which includes sending to the VPN client certain configuration items it will use to communicate with the network during a secure VPN communication session. These configuration items can be, among other things, internal IP addresses, internal netmasks, and internal DNS addresses, were the internal prefix indicates that these items relate to an internal network which the wireless phone is directly communicating with. The mode configuration process is optional if the phone has been pre-configured with an internal IP address, internal netmasks, and internal DNS addresses for instance.

The first phase of the IKE process is referred to as the main or aggressive mode and is generally used to negotiate and establish a SA for subsequent IKE communication. More specifically, the VPN server and the VPN client generate a well known Diffie-Hellman shared value that is used as the base for a shared key, and further IKE communication is encrypted using this shared key. The second phase of the IKE process uses the SA established in the first phase to negotiate one or more SAs that will be used during a communications session between the wireless phone and the network to provide a secure VPN link. Hereinafter, and for the purposes of describing our invention, we will describe the initialization of the secure VPN link in terms of a three phase process with the first phase being phase one of the IKE process, phase two being the mode configuration process, and phase three being phase two of the IKE process described above. We will now turn to a description of the apparatus and method used to implement our inventive hybrid VPN client.

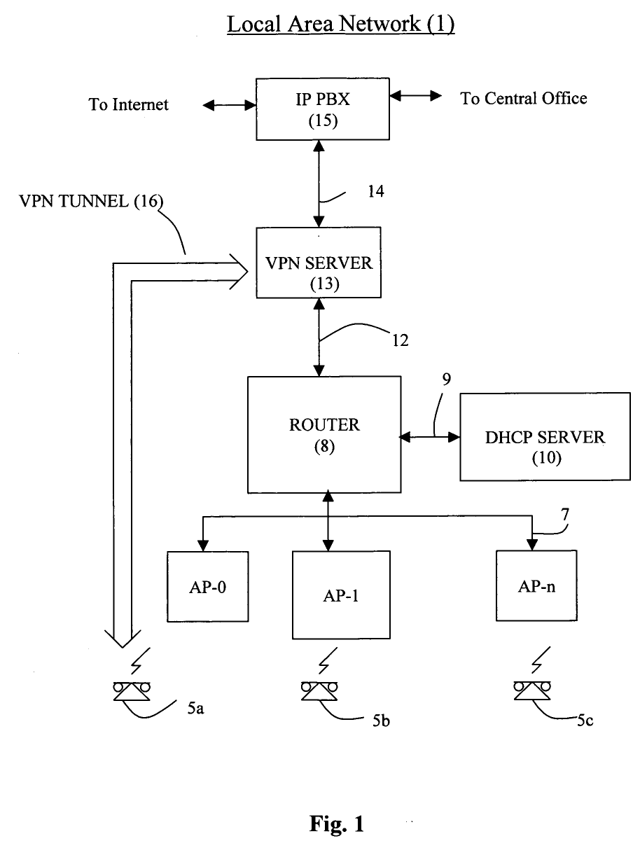

FIG. 1 illustrates the general architecture of a local area network or LAN (1) that is configured to support the establishment and maintenance of one or more secure VPN communication links, hereinafter referred to simply as a VPN link, between at least one wireless communications device and the LAN. The wireless communication devices in this case are wireless phones or simply phones 5a, 5b & 5c which are designed to support the well known IEEE 802.11 standards for Information technology—Telecommunications and information exchange between systems—Local and metropolitan area networks. These phones could be designed to support a variety of other wireless communication protocols such as 802.16, 802.20, DECT, Bluetooth, GSM, and CDMA to name a few. Each phone incorporates a novel hybrid VPN client, which generally operates to establish, maintain and break down VPN links, and a telephony application, which generally operates to open and close sockets, create voice/data streams which it sends to the socket for transmission by the phone. More specifically, the hybrid VPN client runs a three-phase process for the initialization of a VPN link as briefly described in the previous paragraph. The phones are in radio communication with one or more of access points, AP-0, AP-1, and AP-2 each of which also support the 802.11 standards as well as the well known IEEE 802.3 standard, otherwise know as the Ethernet standard. It should be understood that the APs which support other wired communication network standards can also be used, such as token ring or FDDI. These access points generally operate to receive the wireless voice signals from the wireless phones, demodulate and format the signals into packets of voice information in the 802.11 format and then convert the voice information from the 802.11 format to packets in the 802.3 Ethernet format which then can be sent to router (8) over a wired Ethernet network communication link (7). Suitable APs are sold by many vendors including Cisco, Aruba, or Trapeze Networks. Router (8) or alternatively a switch or some other suitable network device, which supports the Ethernet communications standard, is configured to receive packets from the access points and directs them to either a server (10) running the dynamic host configuration protocol (DHCP), in the event that the packets containing messaging information, or to the VPN server (13) in the event that the packets contain voice information. Generally speaking, a server that supports DHCP typically provides configuration parameters specific to the DHCP requesting client, such as DNS server addresses, a DNS name, gateway IP address, broadcast address, subnet mask and so forth. The DHCP server also provides a mechanism for the allocation of IP addresses to clients such as a wireless communications device which in this case is a phone. The VPN server (13) generally operates, in conjunction with the hybrid VPN client on the phones, to perform the three phase process for initializing and maintaining a VPN link (16) during a communication session. Generally, a virtual private network is a private communications network usually within a company, or by several different companies or organizations, to communicate over a public network. VPN messages are carried on public networking infrastructure using standard protocols, or over a service providers network providing VPN service guarded by well defined service agreements (SAs) between the customer or client and the service providers servers IPsec protocols such as the well known AH and ESP protocols. The IP-PBX (15) is a public branch exchange or local telephone switch that provides LAN clients with communication access to either a central office switch or the Internet via some other network device, such as a router. The process by which a secure VPN link is initialized and maintained between one of the phones and the VPN server will be described later in this application. It should be understood, that even though the router (8), DHCP server (10), VPN server (13) and IP-PBX (15) described in the preferred embodiment support the Ethernet standard, they could be easily designed or modified to support other data communication network standards, such as token ring or FDDI, for instance.

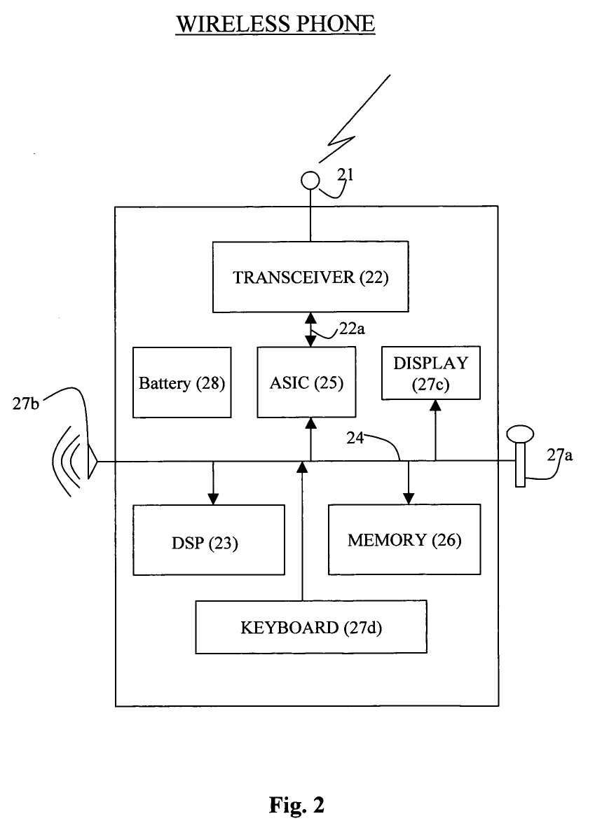

FIG. 2 is a high level functional block diagram depicting one of the phones 5a, 5b, or 5c. As mentioned earlier, the phones support the IEEE 802.11 standards, but could be designed to support other wireless communication standards. Phone (5a) has an antenna (21) which operates to propagate wireless voice signals and is the initial reception point for incoming wireless voice signals. The antenna is connected to transceiver (22) which operates to demodulate the signals containing voice information received from the antenna via the access point, AP-0 for instance, of FIG. 1. The transceiver is connected over a parallel bus (24) to ASIC (25) which implements the hardware portion of the hybrid VPN client, to DSP (23) which implements the software portion of the hybrid VPN client, to memory (26), to keyboard (27d), and to display (27c). In this case, the transceiver is a direct sequence spread spectrum device, but it could implement other physical techniques for wireless communication. The ASIC contains algorithms that are utilized to enable the secure transmission of voice packets over a public network and these algorithms will be referred to generally in this application as packet security algorithms. The ASIC also implements certain aspects of an information communications application, which in this case is a telephony application. The process by which a telephony application is designed and how a wireless phone runs the application is well known to those skilled in the art of wireless telephony and so will not be described in this application in any detail. The packet security algorithms contained on the ASIC will be described later in more detail with reference to FIG. 4.

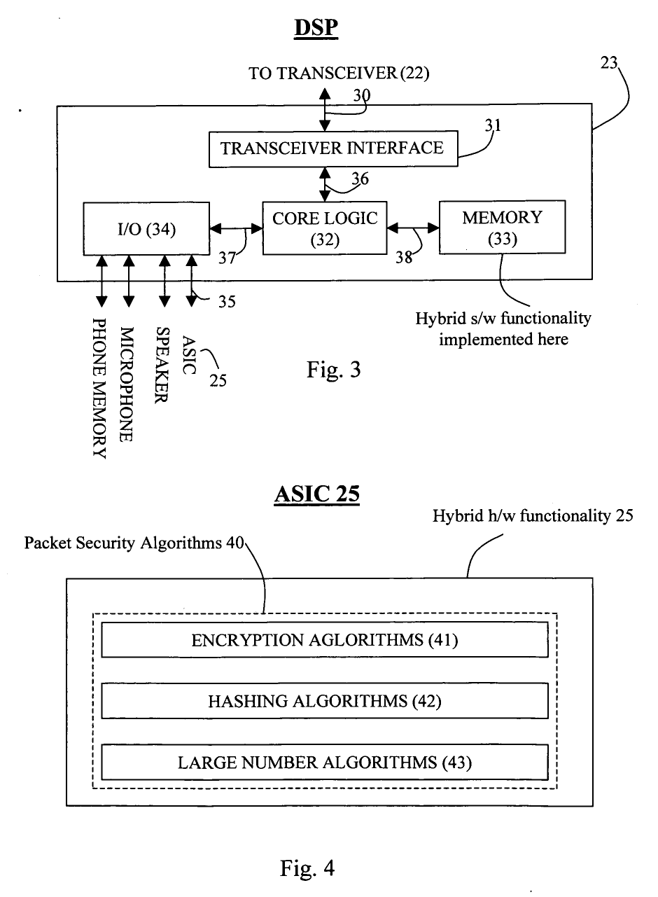

Continuing to refer to FIG. 2, the DSP (23), in the preferred embodiment, is a Texas Instruments TMS320C5410 digital signal processor, but this invention is by no means limited to using this particular processor. The DSP generally functions, in conjunction with the memory (26) and ASIC (25), to manage the operation of the telephony application and to manage the operation of the hybrid VPN client. This includes such things as initiating, maintaining, and tearing down secure VPN links. Among other things, the software portion of the hybrid VPN client is implemented on the DSP. This will be described in more detail later with reference to FIG. 3. Memory (26), which could be EEPROM, RAM, or flash memory, is generally employed to store the telephony application and certain operational parameters used by the hybrid VPN client to set up and maintain secure VPN links. The operational parameters stored in memory (26) can include IP addresses, keys both public and private, hash information, and device identification information such as user name, password, and phone type. The phone (5a) also has a microphone (27a), a speaker (27b), an LCD display (27c), a keyboard (27d), and a battery (28). Although the power connections from the battery (28) to other functional blocks in FIG. 2 are not shown, it should be understood that all of the functional blocks in this diagram do receive power from this battery. The hybrid VPN client in this phone is designed to provide a secure VPN link with the minimum in communication delay or latency and this hybrid VPN client is also designed to consume a minimum amount of power. Communications latency and power consumption will be referred to as communications device operating characteristics.

FIG. 3 is a functional block diagram of the DSP (23). Generally, packets of voice or data information are received by the DSP from the transceiver (22) at interface (31) where they are sent to the core logic (32) for processing. The core logic generally operates, in conjunction with memory (33) and with the ASIC (25) of FIG. 2 to initialize, maintain, and tear down secure VPN links. Continuing to refer to FIG. 3, instructions stored in memory (33) implement the software portion of the VPN client that the DSP core logic uses to run the three phase process for establishing and maintaining a secure VPN link. Empirical and analytical methods were applied to the design of the hybrid VPN client in order to determine which elements of the three phase internet VPN link establishment process are most advantageously implemented in the software portion of the client and in the hardware portion of the client in order to minimize certain wireless communications device operating characteristics, which in this case we will refer to as the communications latency and power consumption.

As the result of the empirical and analytical process above, and in the preferred embodiment of our invention, the hybrid VPN client utilizes the following list of instructions which are stored in memory (33) and represent the software portion of the hybrid VPN client. Although we have listed those software instructions used to implement this particular embodiment our invention, the IKE protocol as described by RFC 2409 could be implemented using other or similar instructions to affect the same or similar result and we do not believe that the hybrid VPN client of our invention is limited by this list in any way.

### Hybrid VPN Client Software Instructions

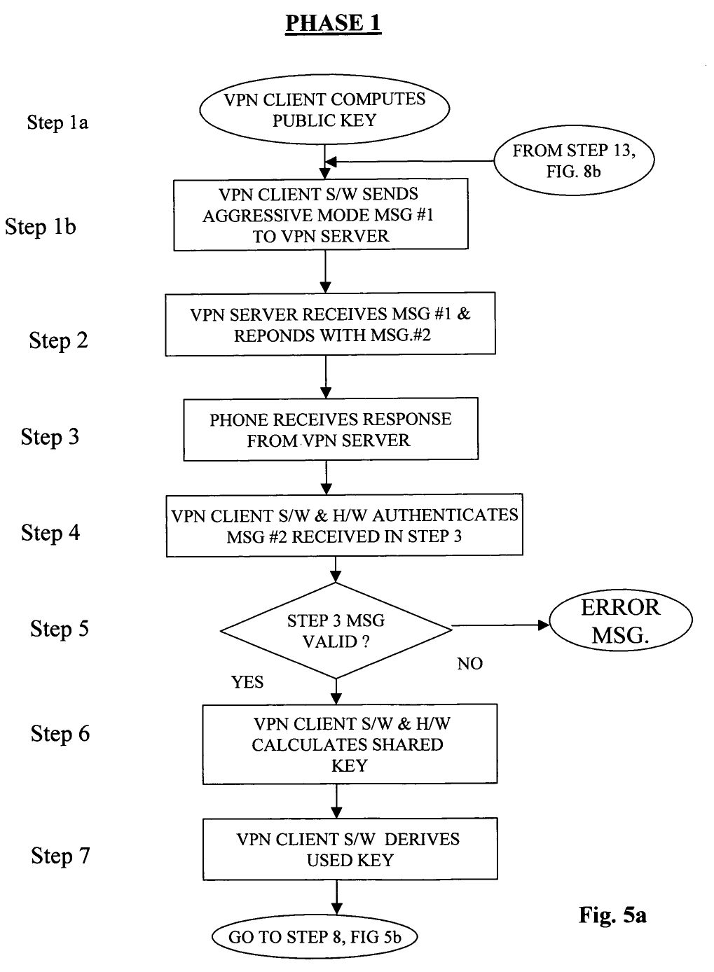

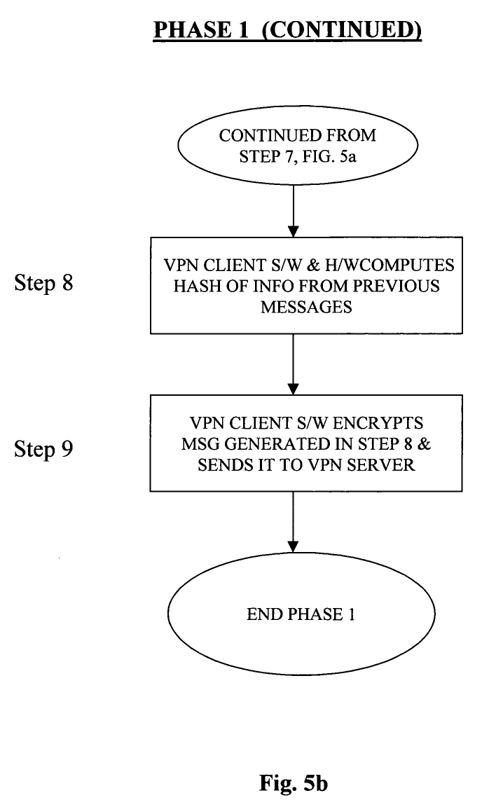

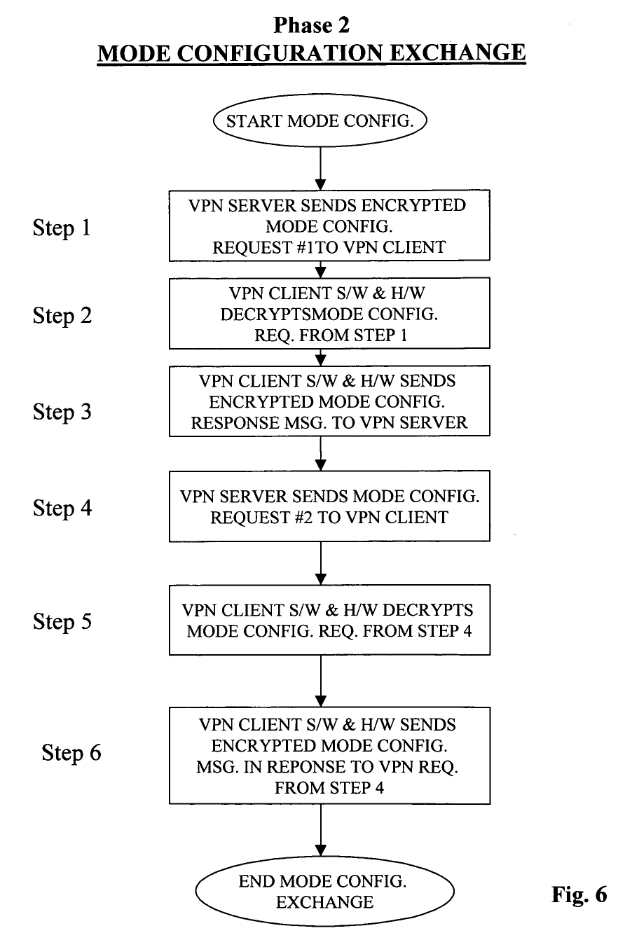

1. Initialize connection to access point and request an IP address from the DHCP server.
2. Select a shared secret key at random and compute the modular exponentiation of said key using a large number algorithm stored in ASIC 25 of FIG. 4. The Montgomery Modular Exponentiation algorithm is an example of such a large number algorithm that could be used. This results in the VPN clients public key. This key will be exchanged with the VPN server using the Diffie-Hellman exchange which will be described later with reference to FIG. 5a. The shared secret key or keys can be stored in DSP memory (33) of FIG. 3.
3. Send an aggressive mode message to VPN server containing, among other things, a 30 proposed security association (SA), the public key computed as result of instruction #2 above and a vendor configuration payload. The vendor configuration payload is used to identify the VPN client as being capable of negotiating with the VPN server during the mode configuration portion of the VPN session initialization. The vendor configuration payload is specifically targeted at a particular implementation of a VPN server, so while it is defined as part of this embodiment, it is not specific to the invention.
4. Instruct the ASIC to utilize one of the hashing algorithms (42), which will be described later with reference to FIG. 4, to calculate a computationally intensive hash of a message received from the VPN server. The message in this case could be one of a number of messages received from the VPN server, and could be for instance a message from the VPN server specifying the SA proposed by the hybrid VPN client or a mode configuration request message which is described later with reference to FIG. 6. Hashing algorithms are typically used to validate that the contents of the received message are the same as the contents of the message as originally sent this is accomplished by the hash algorithm creating a digital signature of a message prior to its being sent, sending the message and having the receiving device calculate another digital signature of the message and comparing the two. If the two signatures do not match, then the message was probably corrupted during transmission and could be resent.
5. Read the result from the ASIC generated as the result of instruction #4 and compare it to the proper result or digital signature embedded in the message. This digital signature is contained in the Authentication data field of a message transmitted according the Encapsulated Security Payload (ESP) protocol.
6. Record the VPN server's public key information that was contained in the message if the result is correct.
7. Instruct ASIC to utilize one of the large number algorithms (43), described later with reference to FIG. 4, to manipulate the key material, recorded in instruction 6 above, to generate the common shared secret key that will be used by both the VPN server and the VPN client. This result is hereafter referred to as the shared secret key. The large number algorithm in this case is a modular exponentiation algorithm.
8. Read the shared secret key from the ASIC that was generated as the result of instruction #7. The shared secret key is used to derive the keys that will be used for the IKE process described previously. The keys used for the IKE process are derived by iteratively utilizing a combination of the hashing algorithms, such as MD5 or SHA1 which are implemented in the ASIC, and software instructions which direct the ASIC to perform the necessary hashing operations on specific pieces of data, and then manipulating those results in software. This process for deriving IKE keys is well know to practitioners and so will not be described here in detail.
9. Instruct ASIC to encrypt the hash of the information exchanged in the previous messages, using an encryption algorithm agreed to during phase one of the IKE, and send the encrypted hash to VPN server. The information being hashed can be key information, SA attribute information, and vendor configuration payload information for instance.
10. Store mode configuration request message #1 received from VPN server
11. Remove the headers and non-encrypted portions of the mode configuration request message #1 stored as result of instruction #10, and instruct the ASIC to decrypt the remainder of the mode configuration request message from VPN server using one of the agreed to encryption algorithms and a key derived as the result of instruct #8.
12. Instruct ASIC repeatedly (means that that the ASIC hash engine is called multiple times in order to complete the calculation) to calculate a hash of the mode configuration message #1 received from the VPN server that was stored as the result of instruction #10 and decrypted as the result of instruction #1 using a key provided by the software. Compare it to the expected digital signature value embedded in the message.
13. Instruct ASIC repeatedly to calculate a hash of the relevant portion of a mode configuration response message. The relevant portion in this case includes such items as IP addresses, netmasks, and DNS addresses.
14. Attach the digital signature calculated as the result of the hash operation in instruction 13 to the authentication data field of the mode configuration response message and instruct ASIC to encrypt the resulting message. Read the encrypted message from the ASIC and send to the VPN server.
15. Instruct ASIC to decrypt mode configuration request message #2 from VPN server.
16. Instruct ASIC repeatedly to calculate a hash of the mode configuration request message #2 from the VPN server and compare the result to the expected value of the digital signature embedded in the message.
17. Extract the protected network IP address that the hybrid VPN client should use from the message decrypted as the result of instruction #15 and validated as the result of instruction #16, and store the IP address.
18. Instruct ASIC to repeatedly calculate a hash on the relevant portion of the mode configuration response message (ACK) with the key provided.
19. Attach the digital signature calculated as the result of the hash operation in instruction #18 to the authentication data field of the mode configuration response message and instruct ASIC to encrypt the resulting message. Read the encrypted message from the ASIC and send to the VPN server.
20. Instruct ASIC to decrypt quick mode message from VPN server. Read the result, and extract and store relevant information from the decrypted message.
21. Instruct ASIC repeatedly to calculate a hash of quick mode message from the VPN server. Compare the result to the expected value embedded in the message.
22. Instruct the ASIC to compute a hash on the relevant portion of a response to the quick mode message decrypted as the result of instruction #20.
23. Attach the digital signature calculated as the result of the hash operation in instruction #22 with a response to the quick mode message from the VPN server, and instruct ASIC to encrypt the resulting message. Read the encrypted message from the ASIC and send to the VPN server.
24. Instruct ASIC to decrypt quick mode message which contains the SA that will be used for VPN tunnel packets. Read the result, and extract the SA that will be used by the Encapsulated Security Protocol for transmission of encrypted data messages.
25. Instruct ASIC repeatedly to calculate a hash on the relevant portion of the quick mode response message received in as the result of instruction #24.
26. Extract from message, decrypted as the result of instruction #24 and validated as the result of instruction #25, the SA that will be used by the Encapsulated Security Protocol for transmission of the encrypted data messages.
27. Calculate the key material required for transmission of data frames by repeatedly computing an HMAC derivative of information exchanged during quick mode and keys derived as the result of instruction #8. This repetitive process is implemented using a mixture of software instructions and algorithms in the ASIC. At this point the tunnel is established, and sufficient information exists to allow the VPN client to derive per message encryption keys.

Once the VPN tunnel is established, the phone will now attempt to communicate with the IP-PBX using network packets. Since these packets are being sent to the IP-PBX, they are encrypted and hashed by the hybrid VPN client software before being sent using keys derived from the information calculated as the result of instruction #24 and the hardware encryption and hashing algorithms contained in the ASIC. Any packets received back from the IP-PBX will have been encrypted by the VPN server prior to transmission, and then sent to the client, which will decrypt and validate them and pass them to the telephony application in the phone to then interpret.

FIG. 4 is a high level block diagram showing the packet security algorithms (40) contained on the ASIC (25) which is used to implement the preferred embodiment of the hardware portion of the hybrid VPN client. Although we use an ASIC in the preferred embodiment, our invention is not limited to the use of an ASIC as we could have used a DSP or some other processor with memory, generically referred to here as an application processor, to implement our invention. Hardware module (41) contains encryption algorithms used to encrypt packets of voice or signaling information to be sent over the network after the VPN tunnel has been initialized and may include such encryption algorithms as the well known AES and DES algorithms. Hardware module (42) contains hashing algorithms, such as the well known MD5 and SHA1 hash algorithms. These hash algorithms are used to verify that messages are not corrupted during transmission and generally operate to calculate a digital signature which is included in the authentication data field of a message encrypted according to the ESP protocol. Hardware module (43) contains complex mathematical algorithms, such as a modular exponentiation algorithm, which are required to be used by the encryption algorithms that require modular exponentiation calculations. It should be understood that other algorithms could be implemented in this ASIC to provide similar functionality and we have only used a subset of all of the algorithms that could be utilized to implement the functionality/processes required for a VPN client to initialize and maintain a VPN tunnel.

The manner in which the software and hardware portions of the hybrid VPN client work cooperatively to run a three-phase process to initialize and maintain a secure VPN link will be described with reference to FIGS. 5a, 5b, 6, and 7. Prior to using a phone with the hybrid VPN client of our invention, it is necessary to pre-configure the phone to use either a static IP configuration or dynamic host configuration protocol (DHCP), to configure the wireless phone with the address of the VPN server, and to configure the preferred SA settings that should be used for establishing the VPN tunnel. For the purposes of this description, it should be assumed that the wireless phone is pre-configured to use DHCP and that the DHCP server address is stored in memory (26) of the phone, and that a selection of SA settings has been made that is compatible with the VPN server in use. At this point the wireless phone can be powered on and the hybrid VPN client software proceeds to connect to the LAN through one of the APs. If the phone was configured for DHCP, then the hybrid VPN client initiates the sending of a request to the DHCP server to obtain an IP address that can be used for identification on the LAN (1).

FIG. 5a is a logical flow diagram illustrating how the hybrid VPN client software and hardware modules work together to perform phase one of the process to initialize a secure VPN link which process is based on the well known IETF RFC 2409. Starting with Step 1a, the hybrid VPN client software randomly selects a shared secret key from DSP (23) memory (33), as illustrated in FIG. 3, and instructs the hardware to compute the modular exponentiation of this key using the large number algorithm (43) of FIG. 4. This results in the hybrid VPN client's public key, which will be exchanged with the VPN server using the well known Diffie-Hellman key exchange protocol. The Diffie-Hellman key exchange is a cryptographic protocol which allows two devices that have no prior knowledge of each other to negotiate to establish a shared secret key over an insecure communications channel. This key can then be used to encrypt subsequent communications using a symmetric key cipher.

Continuing to refer to FIG. 5a, in Step 1b the hybrid VPN client software initiates sending an aggressive mode message #1 to the VPN server which contains a first security association (SA) proposal that includes certain attributes and a vendor extension payload that is used to identify the client as being capable of negotiating the mode configuration step that will be described with reference to FIG. 6 below. In Step 2, The VPN server receives the aggressive mode message #1 and responds with message #2 of the negotiation specifying the first SA that was selected by the hybrid VPN client. In Step 3, the wireless phone receives message #2 from the VPN server. In Step (4), the hybrid VPN client software authenticates message #2 from the VPN server by instructing the ASIC (25) of FIG. 1 to perform a hash using either the SHA1 or MD5 algorithms, stored in the ASIC as hashing algorithms (42), and comparing the results of that hash to the digital signature included in the message. In Step 5, if message #2 is validated, the process proceeds to Step 6, otherwise the hybrid VPN client issues an error message and message is retransmitted or the process of establishing the session stops. Using the VPN server's pubic key information received from the VPN server in message #2 and the VPN client's private key, the hybrid VPN client software in Step 6 instructs the hybrid VPN client hardware uses modular exponentiation algorithm store in hardware module (43) of ASIC (25), as shown in FIG. 4, to begin a modular exponentiation calculation to compute the shared key. In Step 7, the hybrid VPN client software derives the IKE keys from the shared key generated by the hardware in Step 6 above. The shared key is never transmitted in a packet on the LAN during a VPN session.

Referring now to FIG. 5b, which is a continuation of FIG. 5a, in Step 8, the hybrid VPN client software instructs the hybrid VPN client hardware to compute a hash, using one of the hash algorithms stored in hardware module (42) of ASIC (25) as shown in FIG. 4, of the relevant information from messages received during step 3, which in this case would be the SA attributes. The hash is calculated by having the software call the ASIC (25) hardware hash algorithms (42) multiple times, each time combining the result of the previous hash with other information, such as HMAC padding, to create the input to the next hash. The end result is the calculation of a hash. In Step 9, the hybrid VPN client software instructs the hybrid VPN client hardware to encrypt the message containing the hash calculated in Step 8 using the SA encryption method specified in Step 2 above and the software then initiates the sending of this encrypted message to the VPN server. This completes phase one of the IKE exchange.

At this point the VPN server initiates a mode configuration exchange process as defined in the IETF draft document “The ISAKMP Configuration Method (draft-dukes-ike-mode-cfg-02.txt) and which will be described in detail with reference to the logical flow diagram of FIG. 6. This mode configuration method is used in the event that it is necessary to exchange configuration attributes in a secure manner. The configuration attributes are contained in the payload of a configuration exchange message and can include such items as an internal IP address, netmask, DNS address, and DHCP server address.

The optional mode configuration exchange process, which we refer to as phase two of the process used to initialize a secure VPN link, will now be described with reference to FIG. 6. In Step 1, the VPN server sends an encrypted mode configuration request message #1, with a hash, to the hybrid VPN client. This request is encrypted using the SA encryption method that was selected in phase one of the IKE process described with reference to FIG. 5a above. In Step 2, the hybrid VPN client software instructs the hybrid VPN client hardware to decrypt the mode configuration request sent by the VPN server in Step 1 using the SA encryption method that was selected in phase one of the secure VPN link initialization process described with reference to FIG. 5a above. The hybrid VPN client software also uses the hybrid VPN client hardware repeatedly to calculate a hash of the received message in order to validate it against the hash value that was included in the message. In Step 3 the hybrid VPN client software repeatedly uses the hybrid VPN client hardware to calculate a hash of the unencrypted mode configuration response message first using the SA hash method selected in phase one of the secure VPN link initialization process, then encrypt a concatenation of the message and the hash using the SA encryption method selected in phase one of the secure VPN link initialization process, which contains some identification information for the phone. The hybrid VPN client software then initiates the sending of this response message to the VPN server. In Step 4, the VPN server, after receiving the response message from the hybrid VPN client, sends a mode configuration request message #2 to the hybrid VPN client which contains the IP address that the wireless phone should use when communicating with devices on the secure side of the VPN server, such as the IP PBX (15). In Step 5, the hybrid VPN client software instructs the hybrid VPN client hardware to decrypt mode configuration request message #2 and then instructs the hardware to calculate a hash of the decrypted mode configuration request message #2 using the SA encryption and hash methods that were selected in phase one of the secure VPN link initialization process and which is described with reference to FIG. 5a above. The hash calculated above is compared to the hash value embedded in message #2, and assuming that the two hash values match, the protected IP address is extracted from the message and stored in memory. In Step 6, the hybrid VPN client software instructs the hybrid VPN client hardware to first calculate a hash of a mode configuration response message using the SA hash method selected in phase one of the secure VPN link initialization process, then encrypt a concatenation of the message and the hash using the SA encryption method, also selected in phase one, to acknowledge receipt of the mode configuration message #2 and the software initiates the sending of the message.

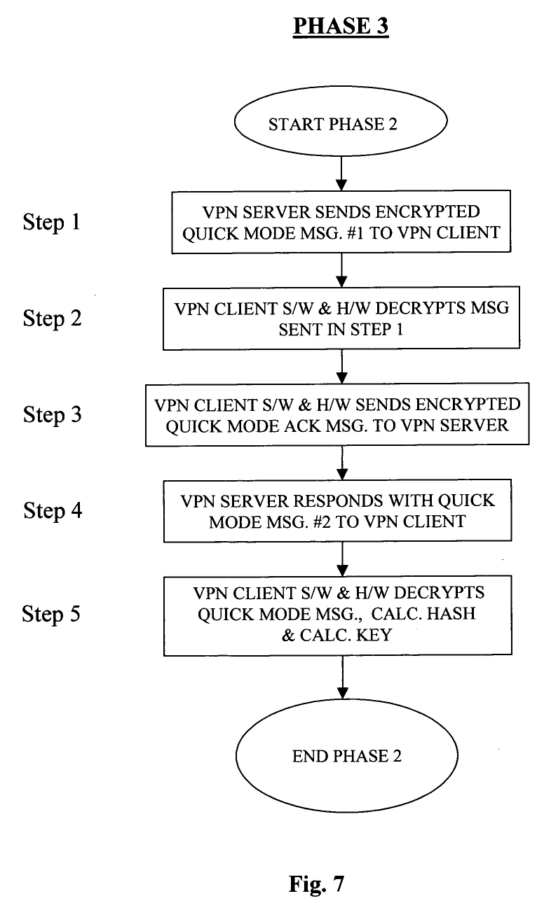

Having completed the mode configuration exchange process, the hybrid VPN client now proceeds to complete phase three of the secure VPN link initialization process, otherwise known as the quick mode phase of the IKE process, which will be described in detail with reference to FIG. 7. In Step 1 the VPN server sends a quick mode message #1 containing a second SA proposal, selected by the VPN server, to the hybrid VPN client. This quick mode message is hashed and encrypted using the SA encryption and hash methods selected in phase one of the secure VPN link initialization process. In Step 2, the hybrid VPN client receives the quick mode message from the VPN server and the client software instructs the hybrid VPN client hardware to decrypt the message using the SA encryption method selected in phase one of the process and calculate a hash of the decrypted message for authentication. If the hash matches and the SA is acceptable to the phone the process continues to step 3, otherwise the phone generates an error message and another quick mode message is sent or the process halts. The decryption process results in a new SA proposal that the hybrid VPN client will use to encrypt the frames of voice data or signaling to the PBX. In Step (3), the hybrid VPN client software selects a new or second SA proposal from the proposals offered by the server that will be used for actual data encryption and instructs the hybrid VPN client hardware to hash an unencrypted quick mode response message containing the second SA proposal and nonce, and encrypt the concatenation of the message and resulting hash. The client hardware encrypts the message using the new or second SA encryption method that was selected by the hybrid VPN client software above and then initiates the sending of the quick mode response message to the VPN server. In Step 4, the VPN server responds to receiving the quick mode response message from the hybrid VPN client by sending quick mode message #2 to provide proof of “liveliness”. In Step 5, the hybrid VPN client software instructs the client hardware in the ASIC to decrypt quick mode message #2 and to repeatedly calculate the hash of the quick mode message #2. The hybrid VPN client software then extracts the second SA that will be used by the encapsulated security protocol for transmission of the encrypted data messages. Also, in Step (5), the software and hardware portions of the hybrid VPN client work together, as previously described with respect to instruction twenty-seven, to calculate the key required for transmission of data frames by repeatedly computing a hashed derivative of information exchanged during quick mode and keys derived in Step 6 in FIG. 5a. This completes the three-phase process for the initialization of a secure VPN link.

Although we have described the IKE process as a three phase process, in the event that the second, optional, mode configuration phase is not employed, the process is then a two phase process.

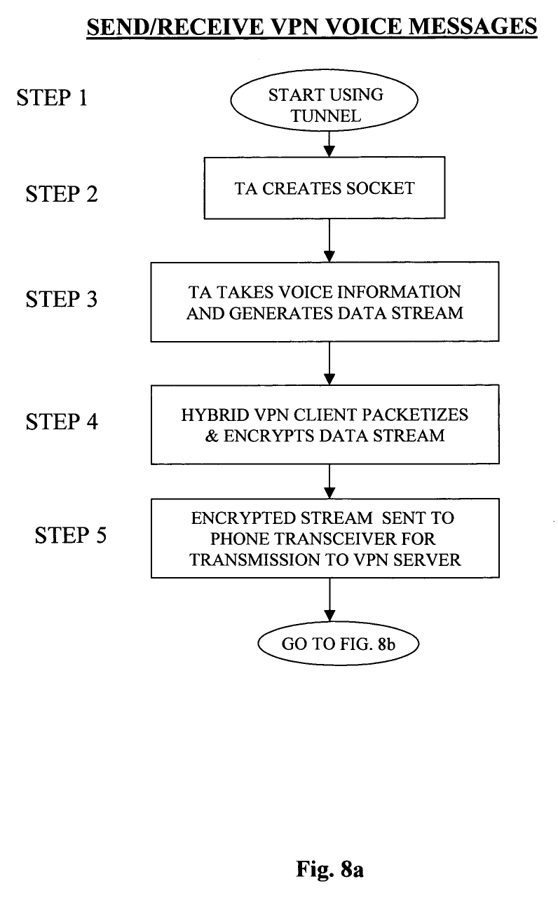

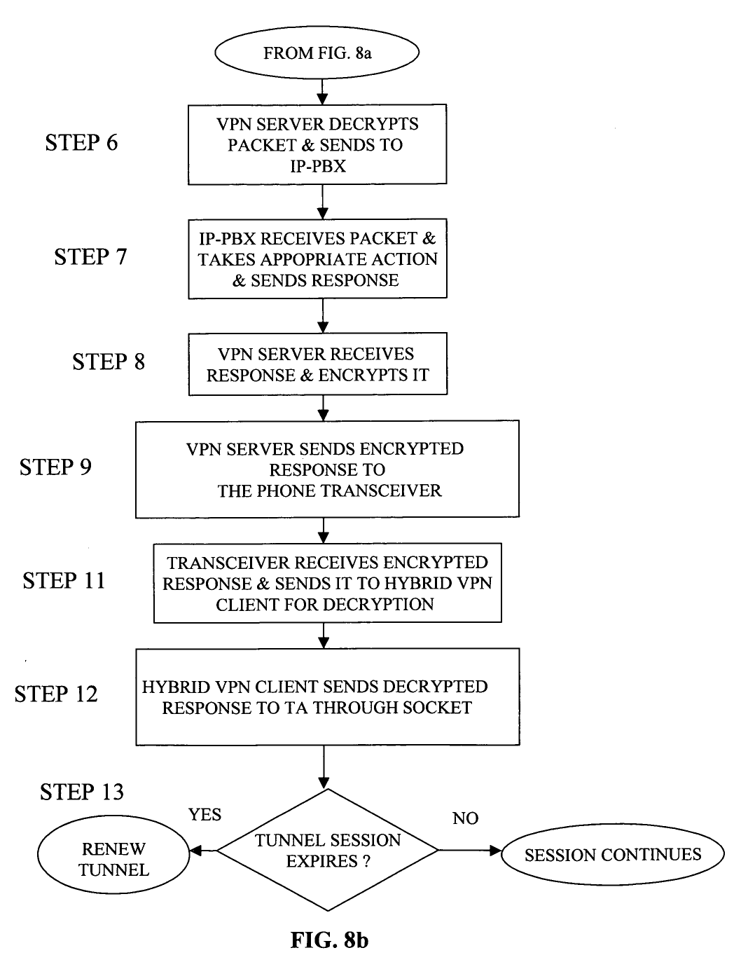

Referring to FIG. 8a, Step 1, once the VPN tunnel has been established, the hybrid VPN client sends a message to the telephony application residing on the wireless phone to indicate that it can proceed to use the secure VPN link for a communication session. In Step 2, the telephony application creates a socket that will be used to direct traffic to the IP-PBX on the protected side of the tunnel. In Step 3, the telephony application creates a stream of voice or data information that it sends to the socket. In Step 4, the hybrid VPN client software takes the data stream, packetizes it, and uses the hybrid VPN client mechanisms, described above with reference to FIGS. 5a, 5b, 6 & 7, of the wireless phone, to encrypt and calculate a hash for the packet. In Step 5, the encrypted packet is sent to the transceiver for transmission to the VPN server. In Step 6, the VPN server decrypts the packet, and sends the unencrypted packet to the IP-PBX. In Step 7, the IP-PBX receives the packet, takes some action based on the contend of the packet, such as creating a connection to the PSTN, or initiating communication with another phone, and sends a response message that ultimately is received by the sending phone. In Step 8, the response message is received by the VPN server, which hashes and encrypts it. In Step 9, the encrypted packet is then sent to the phone transceiver. In Step 10, the phone transceiver receives the packet, determines it was from the VPN server, and if so, sends it to the hybrid VPN client, which decrypts and hashes the packet, and then, in Step 11, sends the decrypted packet to the telephony application through the previously created socket. At any time after this point, in Step 12, the tunnel session may or may not have expired. If it has expired, then the tunnel needs to be renewed otherwise the call continues as described above with reference to FIGS. 8a and 8b and control and audio frames are exchanged in this manner between the telephony application in the phone and the IP-PBX, with either end possibly initiating any given exchange, until the phone is turned off, or the secure VPN link expires, at which time the phone can elect to create or renew the link. So for instance, if phase one of the secure VPN link initialization process described with reference to FIG. 5a expires, the phone or the VPN server can reinitiate the process beginning with Step 1 of FIG. 5a to re-establish the secure VPN link. Similarly, if phase three of the secure VPN link initialization process expires, then either the phone or VPN server could reinitiate the process by returning to Step 1 of FIG. 7.

Therefore, we have explained and described in the forgoing description how it is possible to design hybrid VPN client functionality that can be implemented in a small, inexpensive, battery operated wireless communications device, such as a phone, in a manner that the user would perceive no difference in particular device operating characteristics, which in this case is communications latency and power consumption. We have described how to design of a hybrid VPN client that does not require a more powerful processor, i.e., a processor with a faster clock rate, and wider buses, than used by a standard non-VPN capable phone. Further more, we have described how to design a phone with hybrid VPN client that operates without any appreciable loss of battery life in comparison to a phone with a non-VPN client and we have described how to design a hybrid VPN client that operates without adding to the latency of a secure VPN communications session in comparison to the latency of a non-secure communications session. In this context, “appreciable loss” equates to approximately one percent or less loss in battery life. Still further, we have designed this hybrid VPN client so that there is no measurable increase in latency for the audio communication and only a slight increase in the initial acquisition time due to establishing a VPN tunnel. This increase is approximately one-half second.

We have designed a hybrid VPN client to include a software portion and a hardware portion that work cooperatively to establish and maintain a VPN session. This hybrid VPN client adds very little extra cost to the device which in the case of our embodiment is the cost of the ASIC device which is about $5.00, provides communications latency that is comparable to devices using more powerful and more expensive processors, and uses minimally more power.

The forgoing description of the preferred embodiment of the invention has been presented for the purpose of illustration only. It is not intended to be exhaustive or to limit the invention only to the forms disclosed. Accordingly, any modifications and variations will be apparent to practitioners skilled in the art. Although we have only described how a singe hybrid VPN client operates in conjunction with a single VPN server to establish and maintain a secure VPN link, it should be understood that the phone is in communication with at least one other phone, which would also contain a similar or substantially similar instance of the hybrid VPN client. Further, it should be understood that the division of functionality between the hybrid client software and hardware portions could be different that the division as described in the preferred embodiment of our invention and result in substantially the same functionality with substantially the same latency.

We claim:

1. In a LAN supporting the communication of information among a plurality of preconfigured wireless communication devices, a hybrid VPN client is implemented on at least one of the preconfigured wireless communication devices, the hybrid VPN client comprises:
means for implementing a software portion of the hybrid VPN client;
means for implementing a hardware portion of the hybrid VPN client;
wherein the division of functionality between the software portion and the hardware portion of the hybrid VPN client is selected such that the hybrid VPN client operates to minimize at least one wireless communication device operating characteristic.

2. The at least one wireless communication device operating characteristic of claim 1 is one of power consumption and communications latency.

3. The software means of claim 1 is comprised of instructions stored on a digital signal processor which are used to run the hardware portion of the hybrid VPN client.

4. The software means of claim 3 further comprises instructions stored on a digital signal processor which are used by the preconfigured wireless communications device and the LAN to initiate and maintain a secure VPN link.

5. The hardware means of claim 1 is comprised of a plurality of packet security algorithms that are stored on an application specific processor.

6. The packet security algorithms of claim 5 are comprised of at least one encryption algorithms, at least one hashing algorithm, and at least one large number algorithm.

7. The hardware and software means of claim 1 operate together to support the initialization of a secure VPN link.

8. The initialization of the secure VPN link of claim 7 is a three phase process wherein the first phase is a setup stage for establishing an initial security association between a LAN device and the preconfigured wireless communications device, the second phase is a mode configuration stage for loading an IP address from the LAN device to the preconfigured wireless communications device, and the third phase is a parameter negotiation stage wherein the initial security association established in the first phase is used to create a permanent security association that is used for the communication of information over the secure VPN link.

9. At least one of the plurality of wireless communications devices of claim 1 are preconfigured to include a DHCP address, a VPN server address, and security association settings.

10. In a LAN supporting the communication of information over a secure VPN link between the LAN and at least one preconfigured wireless communications device, the preconfigured wireless communications device includes a hybrid VPN client that employs a method for establishing the secure VPN link that minimizes at least one wireless communications device operating characteristic comprising the steps of:
employing a plurality of instructions stored in a software portion of the hybrid VPN client to manage the operation of a hardware portion of the hybrid VPN client and to access a plurality of operational parameters stored in the preconfigured wireless communications device in order to complete a first phase of a secure VPN link initialization process;
employing a plurality of instructions stored in the software portion of the hybrid VPN client to manage the operation of the hardware portion of the hybrid VPN client and to access a plurality of operational parameters stored in the preconfigured wireless communications device memory in response to one or more requests from the LAN to complete a second phase of the secure VPN link initialization process; and
employing a plurality of instructions stored in the software portion of the hybrid VPN client to manage the operation of the hardware portion of the hybrid VPN client and to access a plurality of operational parameters stored in the preconfigured wireless communications device memory in response to at least one request from the LAN to complete a third phase of the secure VPN link initialization process.

11. The first, second and third phases of the secure VPN link initialization process of claim 10 are respectively a setup stage for establishing a security association between a LAN device and the preconfigured wireless communications, a mode configuration stage for loading an IP address from the LAN device to the preconfigured wireless communications device, and a parameter negotiation stage wherein the initial security association established in the first phase is used to create a permanent security association that is used for the communication of information over the secure VPN link.

12. The plurality of operational parameters of claim 10 is comprised of an IP address, a public key, a private key, configuration information, and identification information.

13. The configuration information of claim 12 is comprised of a DHCP address, a VPN server address and security association settings.

14. The identification information of claim 12 comprises a user name, user password, and phone type.

15. The hardware portion of the hybrid VPN client of claim 10 is comprised of a plurality of packet security algorithms that are stored on an application processor.

16. The packet security algorithms of claim 15 are comprised of at least one encryption algorithm, at least one hashing algorithm and at least one large number algorithm.

17. An apparatus for implementing a hybrid VPN client in a preconfigured wireless communications device, the apparatus comprising:
an application processor apparatus for implementing packet security algorithms associated with a hardware portion of the hybrid VPN client, and
a processor apparatus for storing and executing software instructions associated with a software portion of the hybrid VPN client to run the hardware portion of the hybrid VPN client and to initiate and maintain a secure VPN link.

18. The hardware and software portions of the hybrid VPN client apparatus of claim 17 are divided between the application processor apparatus and the processor apparatus such that the hybrid VPN client operates to minimize at least one wireless communications device operating characteristic.

19. The at least one wireless communications device operating characteristic of claim 18 can be one of communications latency and power consumption.

20. The packet security algorithms implemented on the application processor apparatus of claim 17 are comprised of at least one encryption algorithm, at least one hashing algorithm, and at least one large number algorithm.

21. The hardware and software portions of the hybrid VPN client of claim 17 operate together to support a secure VPN link initialization process.

22. The secure VPN link initialization process of claim 21 is a three phase process wherein the first phase is a setup stage for establishing an initial security association between a LAN device and the preconfigured wireless communications device, the second phase is a mode configuration stage for loading an IP address from the LAN device to the preconfigured wireless communications device, and the third phase is a parameter negotiation stage wherein the initial security association established in the first phase is used to create a permanent security association that is used for the communication of information over a VPN tunnel.

23. In a LAN supporting the communication of information over a secure VPN link between the LAN and at least one preconfigured wireless communications device, the preconfigured wireless communications device includes a hybrid VPN client that employs a method for establishing the secure VPN link that minimizes at least one wireless communications device operating characteristic comprising the steps of:
employing a plurality of instructions stored in a software portion of the hybrid VPN client to manage the operation of a hardware portion of the hybrid VPN client and to access a plurality of operational parameters stored in the preconfigured wireless communications device in order to complete a first phase of a secure VPN link initialization process;
employing a plurality of instructions stored in the software portion of the hybrid VPN client to manage the operation of the hardware portion of the hybrid VPN client and to access a plurality of operational parameters stored in the preconfigured wireless communications device memory in response to at least one request from the LAN to complete a second phase of the secure VPN link initialization process.
